(19) United States
(12) Patent Application Publication
(10) Pub. No.: US 2026/0339059 A1
(43) Pub. Date: Oct. 29, 2026

(54) OPTICAL CO-PACKAGING DEVICE

(71) Applicant: Delta Electronics, Inc., Taoyuan City (TW)

(72) Inventors: Po-Chen WU, Taoyuan City (TW); Shu-Hong CHU, Taoyuan City (TW)

(21) Appl. No.: 19/305,464

(22) Filed: Aug. 20, 2025

(30) Foreign Application Priority Data
Apr. 25, 2025 (CN) 202510526013.0

(51) Int. Cl. G02B 6/44

(52) U.S. Cl. CPC G02B 6/4455; G02B 6/44524

(57) ABSTRACT

An optical co-packaging device is provided. The optical co-packaging device includes a housing, a front panel, a plurality of guiding rods, a plurality of first bearing units, an application-specific integrated circuit, and a plurality of optical I/O modules. The front panel is detachably connected to the housing. Each guiding rod has a first end affixed to the front panel. The first bearing units are disposed in the housing, wherein each first bearing unit is sleeved around the corresponding guiding rod, such that the front panel is slidable relative to the housing. The application-specific integrated circuit is disposed within the housing. The optical I/O modules are coupled to the application-specific integrated circuit and disposed within the housing.

### CROSS REFERENCE TO RELATED APPLICATIONS

This Application claims priority of China Patent Application No. 2025105260130, filed on Apr. 25, 2025, the entirety of which is incorporated by reference herein.

### BACKGROUND OF THE INVENTION

### Field of the Invention

The present invention relates to an optical co-packaging device, and, in particular, it relates to an electronic device utilizing optical co-packaging technology.

### Description of the Related Art

Co-packaged optics (CPO) is a technology that integrates a switching chip and an optical engine into the same socket, enabling closer coupling between the two to enhance signal transmission efficiency and to reduce power consumption. Compared to a traditional pluggable optics module, CPO technology effectively shortens the distance for electrical signal transmission, thereby reducing power consumption and signal latency. As a result, it is increasingly being used in switches, data centers, and other high-performance computing equipment.

However, despite the significant advantages of CPO technology in terms of performance and energy efficiency, it still faces several challenges in terms of practical application. First, the internal optical modules are more precise and complex, increasing the complexity of the structural design. Additionally, the dense and intricate fiber routing can make cable management difficult, further affecting ease of assembly and maintenance. In conventional optical co-packaging devices, interference from internal components can often complicate maintenance and assembly, thereby raising costs.

Furthermore, the introduction of CPO technology also impacts maintenance strategies. Since optical and electronic components are co-packaged within a single module and connected via optical fiber connectors, a failure in a specific part can be addressed by replacing the corresponding fiber. Therefore, one of the key focuses of this application is how to optimize the design of optical co-packaging to achieve both high performance and maintain-ability.

### BRIEF SUMMARY OF THE INVENTION

In one embodiment, an optical co-packaging device is provided. The optical co-packaging device includes a housing, a front panel, a plurality of guiding rods, a plurality of first bearing units, an application-specific integrated circuit, and a plurality of optical I/O modules. The front panel is detachably connected to the housing. Each guiding rod has a first end affixed to the front panel. The first bearing units are disposed in the housing, wherein each first bearing unit is sleeved around the corresponding guiding rod, such that the front panel is slidable relative to the housing. The application-specific integrated circuit is disposed within the housing. The optical I/O modules are coupled to the application-specific integrated circuit and disposed within the housing.

In one embodiment, the optical co-packaging device further comprises a plurality of stoppers, wherein each stopper is disposed at the second end of the corresponding guiding rod, and the stopper is configured to stop the first bearing unit.

In one embodiment, the optical co-packaging device further comprises a plurality of nuts, wherein each nut is disposed at the second end of the corresponding guiding rod to secure the stopper.

In one embodiment, the optical co-packaging device further comprises a plurality of bolts, wherein each bolt is disposed at the second end of the corresponding guiding rod to secure the stopper.

In one embodiment, each first bearing unit is a ball bearing, and each first bearing unit comprises a plurality of balls in point contact with the guiding rod.

In one embodiment, the optical co-packaging device further comprises a plurality of second bearing units, wherein each second bearing unit is affixed to the front panel and sleeved around the corresponding guiding rod.

In one embodiment, the optical co-packaging device further comprises a plurality of fastening bases, wherein each fastening base is affixed to the front panel and is affixed to the corresponding guiding rod.

In one embodiment, the optical co-packaging device further comprises a plurality of port modules, wherein the port modules are coupled to the optical I/O modules and correspondingly connected to the front panel.

In one embodiment, at least one guiding rod is located below the port module in a vertical direction.

In one embodiment, the front panel comprises a plurality of venting holes, and at least some of the guiding rods are disposed adjacent to the venting holes.

In one embodiment, the optical co-packaging device further comprises an air baffle disposed within the housing, wherein the air baffle covers at least a portion of one of the first bearing units, and the venting holes correspond to the air baffle.

Compared to the conventional optical co-packaging devices, which typically have larger internal components and complex fiber routing, leading to space constraints during maintenance and assembly as well as a higher risk of damage due to component interference or fiber strain, the optical co-packaging device of the embodiment of the invention effectively overcomes these issues. By incorporating a design in which the front panel is slidable relative to the housing, maintenance engineers can more easily access internal components, reducing operational difficulty caused by limited space. Additionally, the optical co-packaging device of the embodiment of the invention is designed with fiber stability in mind. When the front panel slides, the internal fiber routing remains stable, preventing the risk of fiber detachment or damage caused by accidental pulling. Accordingly, the optical co-packaging device of the embodiment of the invention not only creates ample space for maintenance and assembly in an effortless and convenient manner, but also enhances the safety and reliability of the maintenance process, further reducing operational costs and maintenance time, thereby bringing improved efficiency and operability to the practical application of optical co-packaging technology.

### BRIEF DESCRIPTION OF THE DRAWINGS

The present invention can be more fully understood by reading the subsequent detailed description and examples with references made to the accompanying drawings, wherein:

FIG. 1 is a perspective view of an optical co-packaging device of a first embodiment of the invention;

FIG. 2 is a block diagram of the optical co-packaging device of the embodiment of the invention;

FIG. 3 shows the guiding rod and the first bearing unit of the first embodiment of the invention;

FIG. 4A shows the front panel combined to the housing of the embodiment of the invention;

FIG. 4B shows the front panel separated from the housing of the embodiment of the invention;

FIG. 5 shows the guiding rod and the first bearing unit of a second embodiment of the invention; and

FIG. 6 shows the guiding rod and the first bearing unit of a third embodiment of the invention.

### DETAILED DESCRIPTION OF THE INVENTION

The following description is made for the purpose of illustrating the general principles of the invention and should not be taken in a limiting sense. The scope of the invention is best determined by reference to the appended claims.

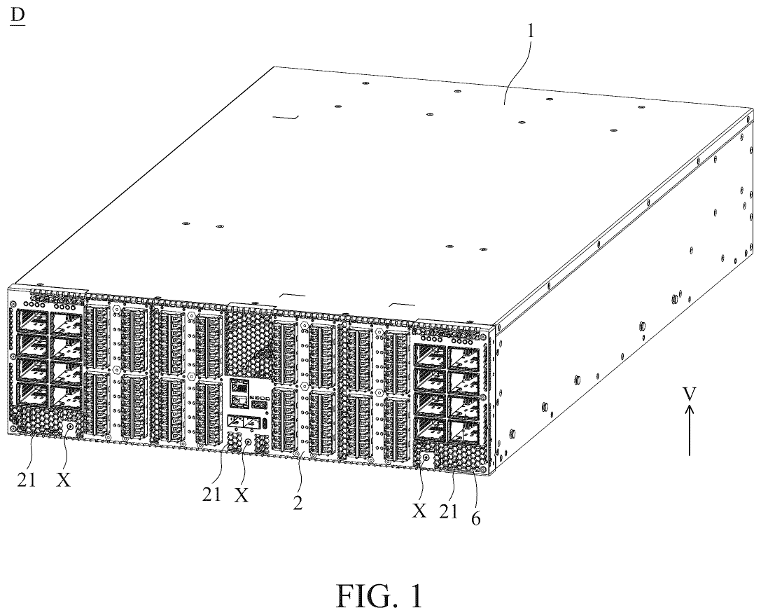

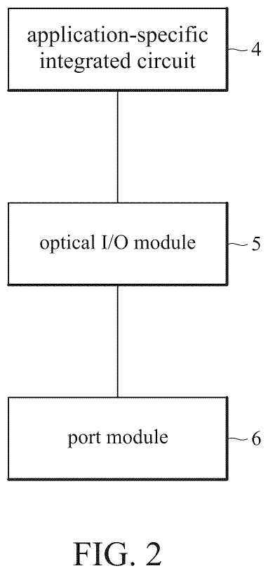

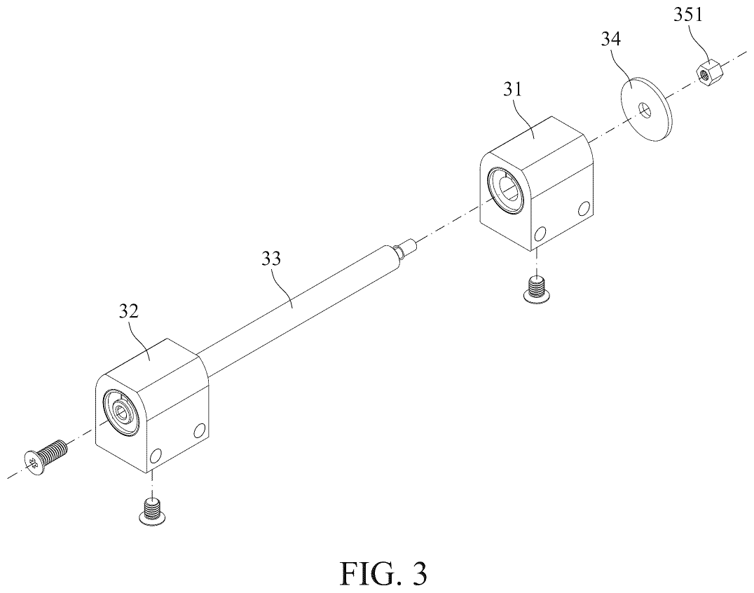

FIG. 1 is a perspective view of an optical co-packaging device of a first embodiment of the invention. FIG. 2 is a block diagram of the optical co-packaging device of the embodiment of the invention. FIG. 3 shows the guiding rod and the first bearing unit of the first embodiment of the invention. With reference to FIGS. 1, 2 and 3, the optical co-packaging device D of the embodiment of the invention includes a housing 1, a front panel 2, a plurality of guiding rods 33, a plurality of first bearing units 31, an application-specific integrated circuit 4 and a plurality of optical I/O modules 5. The front panel 2 is detachably connected to the housing 1. The application-specific integrated circuit 4 is disposed within the housing 1. The optical I/O modules 5 are coupled to the application-specific integrated circuit 4 and disposed within the housing 1.

In some embodiments, the optical co-packaging device may be implemented in the form of a switch, a server, or other suitable equipment. The disclosure is not meant to restrict the invention.

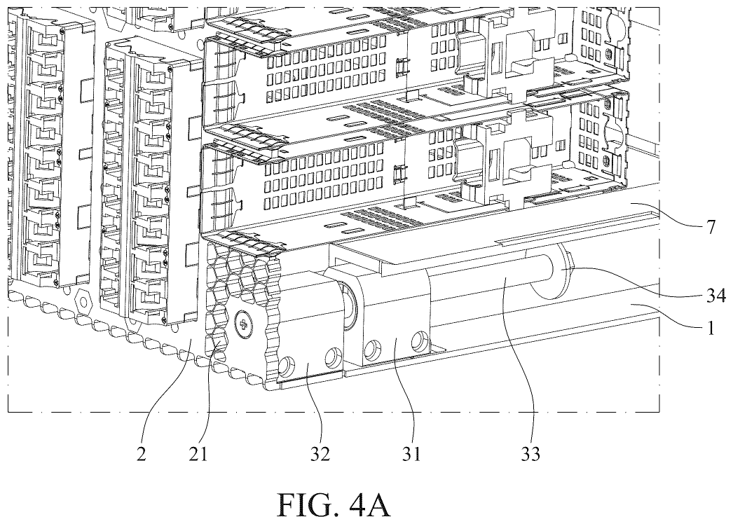

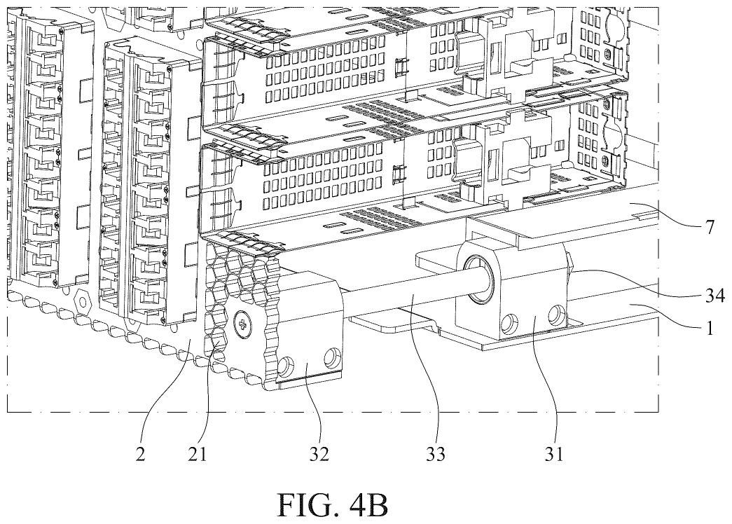

FIG. 4A shows the front panel combined to the housing of the embodiment of the invention. FIG. 4B shows the front panel separated from the housing of the embodiment of the invention. With reference to FIGS. 3, 4A and 4B, each guiding rod 33 has a first end affixed to the front panel 2. The first bearing units 31 are disposed in the housing 1, wherein each first bearing unit 31 is sleeved around the corresponding guiding rod 33, such that the front panel 2 is slidable relative to the housing 1.

With reference to FIGS. 3, 4A and 4B, in one embodiment, one end of the guiding rod 33 is affixed to the front panel 2 by means of screw fastening. The first bearing unit 31 is affixed to the housing 1 by screw fastening as well. The disclosure is not meant to restrict the invention. For example, the first end of the guiding rod 33 may alternatively be affixed to the front panel 2 by riveting, snap-fitting, or other means. Similarly, the first bearing unit 31 may be affixed to the housing 1 by riveting, snap-fitting, or other means.

With reference to FIGS. 3, 4A and 4B, in one embodiment, the optical co-packaging device further comprises a plurality of stoppers 34, wherein each stopper 34 is disposed at the second end of the corresponding guiding rod 33. The stopper 34 is configured to stop the first bearing unit 31.

With reference to FIGS. 3, 4A and 4B, in one embodiment, the optical co-packaging device further comprises a plurality of nuts 351, wherein each nut 351 is disposed at the second end of the corresponding guiding rod 33 to secure the stopper 34.

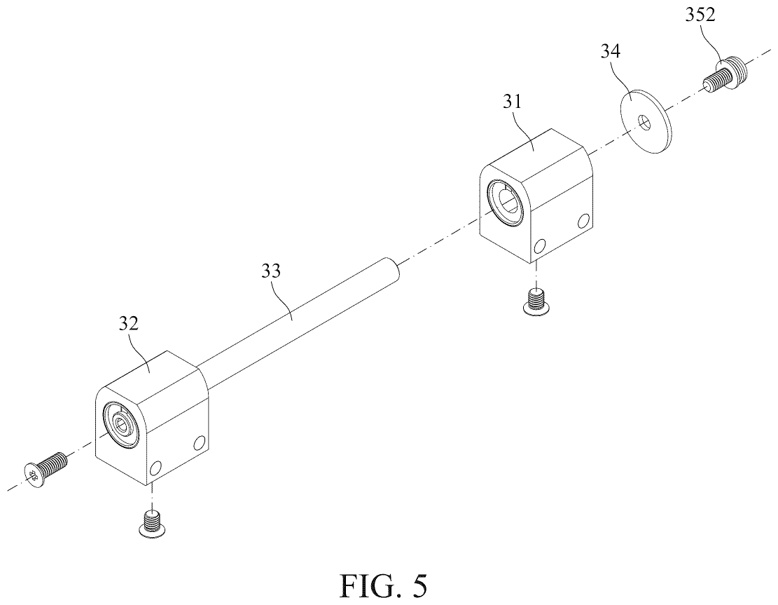

FIG. 5 shows the guiding rod and the first bearing unit of a second embodiment of the invention. With reference to FIG. 5, in one embodiment, the optical co-packaging device further comprises a plurality of bolts 352, wherein each bolt 352 is disposed at the second end of the corresponding guiding rod 33 to secure the stopper 34.

With reference to FIGS. 3 and 5, in one embodiment, each first bearing unit 31 is a ball bearing, and each first bearing unit 31 comprises a plurality of balls (not shown) in point contact with the guiding rod 33. The disclosure is not meant to restrict the invention.

With reference to FIGS. 3 and 5, in one embodiment, the optical co-packaging device further comprises a plurality of second bearing units 32, wherein each second bearing unit 32 is affixed to the front panel 2 and sleeved around the corresponding guiding rod 33.

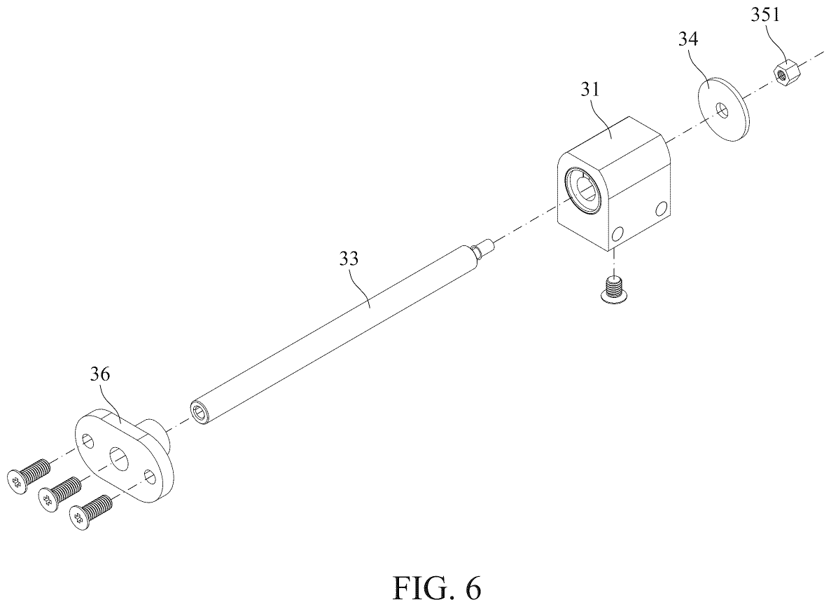

FIG. 6 shows the guiding rod and the first bearing unit of a third embodiment of the invention. With reference to FIG. 6, in one embodiment, the optical co-packaging device further comprises a plurality of fastening bases 36, wherein each fastening base 36 is affixed to the front panel 2 and is affixed to the corresponding guiding rod 33. In one embodiment, the fastening bases 36 are affixed to the front panel 2 by screw fastening.

With reference to FIGS. 1 and 2, in one embodiment, the optical co-packaging device further comprises a plurality of port modules 6, wherein the port modules 6 are coupled to the optical I/O modules 5 via optical fibers (not shown). The port modules 6 are connected to the front panel 2. Particularly, the port modules 6 are correspondingly connected to panels openings on the front panel 2. In one embodiment, at least one guiding rod is located below the port module 6 in a vertical direction V. In one embodiment, the guiding rod is actually disposed at the location indicated by the installation position X. However, the above disclosure is not meant to restrict the invention. The guiding rod may alternatively be disposed at other suitable positions.

With reference to FIG. 1, in one embodiment, the front panel 2 comprises a plurality of venting holes 21, and at least some of the guiding rods are disposed adjacent to the venting holes 21.

With reference to FIGS. 4A and 4B, in one embodiment, the optical co-packaging device further comprises an air baffle 7 disposed within the housing 1, wherein the air baffle 7 covers at least a portion of one of the first bearing units 31, and the venting holes 21 corresponds to the air baffle 7.

Compared to the conventional optical co-packaging devices, which typically have larger internal components and complex fiber routing, leading to space constraints during maintenance and assembly as well as a higher risk of damage due to component interference or fiber strain, the optical co-packaging device of the embodiment of the invention effectively overcomes these issues. By incorporating a design in which the front panel is slidable relative to the housing, maintenance engineers can more easily access internal components, reducing operational difficulty caused by limited space. Additionally, the optical co-packaging device of the embodiment of the invention is designed with fiber stability in mind. When the front panel slides, the internal fiber routing remains stable, preventing the risk of fiber detachment or damage caused by accidental pulling. Accordingly, the optical co-packaging device of the embodiment of the invention not only creates ample space for maintenance and assembly in an effortless and convenient manner, but also enhances the safety and reliability of the maintenance process, further reducing operational costs and maintenance time, thereby bringing improved efficiency and operability to the practical application of optical co-packaging technology.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

1. An optical co-packaging device, comprising:
a housing;
a front panel, detachably connected to the housing;
a plurality of guiding rods, wherein each guiding rod has a first end affixed to the front panel;
a plurality of first bearing units, disposed in the housing, wherein each first bearing unit is sleeved around the corresponding guiding rod, such that the front panel is slidable relative to the housing;
an application-specific integrated circuit, disposed within the housing; and
a plurality of optical I/O modules, coupled to the application-specific integrated circuit and disposed within the housing.

2. The optical co-packaging device as claimed in claim 1, further comprising a plurality of stoppers, wherein each stopper is disposed at a second end of the corresponding guiding rod, and the stopper is configured to stop the first bearing unit.

3. The optical co-packaging device as claimed in claim 2, further comprising a plurality of nuts, wherein each nut is disposed at the second end of the corresponding guiding rod to secure the stopper.

4. The optical co-packaging device as claimed in claim 2, further comprising a plurality of bolts, wherein each bolt is disposed at the second end of the corresponding guiding rod to secure the stopper.

5. The optical co-packaging device as claimed in claim 2, wherein each first bearing unit is a ball bearing, and each first bearing unit comprises a plurality of balls in point contact with the guiding rod.

6. The optical co-packaging device as claimed in claim 3, further comprising a plurality of second bearing units, wherein each second bearing unit is affixed to the front panel and sleeved around the corresponding guiding rod.

7. The optical co-packaging device as claimed in claim 3, further comprising a plurality of fastening bases, wherein each fastening base is affixed to the front panel and is affixed to the corresponding guiding rod.

8. The optical co-packaging device as claimed in claim 1, further comprising a plurality of port modules, wherein the port modules are coupled to the optical I/O modules and correspondingly connected to the front panel.

9. The optical co-packaging device as claimed in claim 8, wherein at least one guiding rod is located below the port module in a vertical direction.

10. The optical co-packaging device as claimed in claim 8, wherein the front panel comprises a plurality of venting holes, and at least some of the guiding rods are disposed adjacent to the venting holes.

11. The optical co-packaging device as claimed in claim 10, further comprising an air baffle disposed within the housing, wherein the air baffle covers at least a portion of one of the first bearing units, and the venting holes correspond to the air baffle.
